(19) United States
(12) Patent Application Publication
(10) Pub. No.: US 2002/0015489 A1
(43) Pub. Date: Feb. 7, 2002

(54) System and method for power feeding a line coupled to an exchange

(76) Inventor: Shimon Ben-David, Binyamina (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/846,271

(22) Filed: May 2, 2001

Related U.S. Application Data
(60) Provisional application No. 60/216,022, filed on Jul. 3, 2000.

(51) Int. Cl. H04M 1/00

(52) U.S. Cl. 379/413

(57) ABSTRACT

In one embodiment, the present invention is directed to a system and method for power-feeding a line coupled to an exchange without disturbing the operation of the exchange. The system may include a power-feeding unit coupled to the line and an adapter coupled to the line, the adapter also coupled to or embedded in a current-consuming device coupled to the line.

### CROSS-REFERENCE TO RELATED APPLICATIONS

The present application clams priority from U.S. Provisional application Serial No. 60/216,022, filed Jul. 3, 2000 which is incorporated herein by reference.

### BACKGROUND OF THE INVENTION

There are many devices plugged into the telephone line at homes or offices that consume so much electrical power that they require power-feeding from the electricity wires via external, bulky and expensive power adapters. Examples of such devices include a cordless telephone base, answering machines, Internet Protocol (IP) telephones, etc.

It is possible to connect a central power supply to the telephone line at one place in a customer premise, which could provide all the required power on the telephone line. However, driving the telephone line with sufficient direct current (DC) power for the operation of several devices could cause He telephone system's central office to mistakenly identify the electrical signal as an “off hook” state, possibly leading to problems and confusion at the telephone system.

### BRIEF DESCRIPTION OF THE DRAWINGS

The subject mater regarded as he invention is particularly pointed out and distinctly claimed in the concluding portion of the specification. The invention, however, both as to organization and method of operation, together with objects, features and advantages thereof, may best be understood by reference to the following detailed description when read with the accompanying drawings in which:

FIG. 1 is a block diagram illustration of an exchange and a customer premises, according to some embodiments of the present invention; and

FIGS. 2A and 2B show a block diagram illustration of an exchange and a customer premises, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

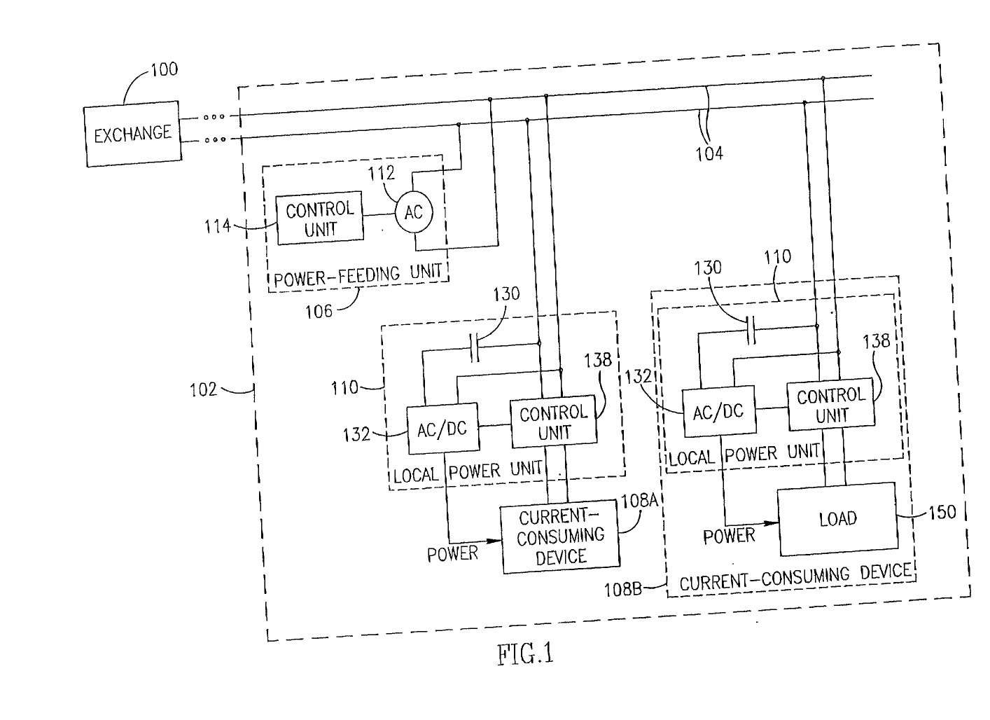

Reference is now made to FIG. 1, which is a block diagram illustration of an exchange 100 and a customer premises 102, according to some embodiments of the present invention. Non-limiting examples of exchange 100 include a private branch exchange (which is located in customer premises 102), a cable exchange and a central office (also known as a public exchange). An electrically conductive line 104 at customer premises 102 may be coupled to exchange 100. Non-limiting examples of line 104 include an internal telephone line and an internal cable.

Customer premises 102 may comprise a power-feeding unit 106 coupled to line 104 and at least one local power unit 110 also coupled to line 104. Customer premises 102 further comprise at least one current-consuming device 108. For example, current-consuming device 108A may be coupled to line 104 via a local power unit 110 that supplies current-consuming device 108A with power. In another example, current-consuming device 108B may be coupled to line 104 and may have local power unit 110 embedded therein.

Power-feeding unit 106 may be adapted to provide power over line 104 to current-consuming devices 108 without disturbing operation of exchange 100 or other devices connected to line 104. In some embodiments of the present invention, power-feeding unit 106 may provide power over line 104 to local power unit 110, which is either coupled to or embedded in current-consuming device 108.

Power-feeding unit 106 may comprise an alternating current (AC) power supply 112 coupled to line 104 and a control unit 114 adapted to control the current, frequency and amplitude of AC power supply 112. The frequency of the signals generated by AC power supply 112 may be above 20 KHz as not to disturb Me operation of exchange 100, which is sensitive to signals of frequency below 16 KHz.

Local power unit 110 may comprise a DC block capacitor 130, an AC/DC converter 132 coupled to line 104 via DC block capacitor 130, and a control unit 138 coupled to line 104 and to AC/DC converter 132. Control unit 138 may be adapted to control AC/DC input impedance according to the frequency and amplitude of the power supply. Control unit 138 may also be adapted to control the power state (e.g. maximum consumption, low power, off state and the like) of current-consuming device 108.

The capacitance of DC block capacitor 130 may be set so that local power unit 110 does not draw DC current over line 104 from exchange 100. AC power supply 112 may generate an AC current over line 104. The AC current may flow through block capacitor 130 to AC/DC converter 132, which may convert it to several DC voltage levels, thus producing power to feed current-consuming device 108A or a load 150 in current-consuming device 108B.

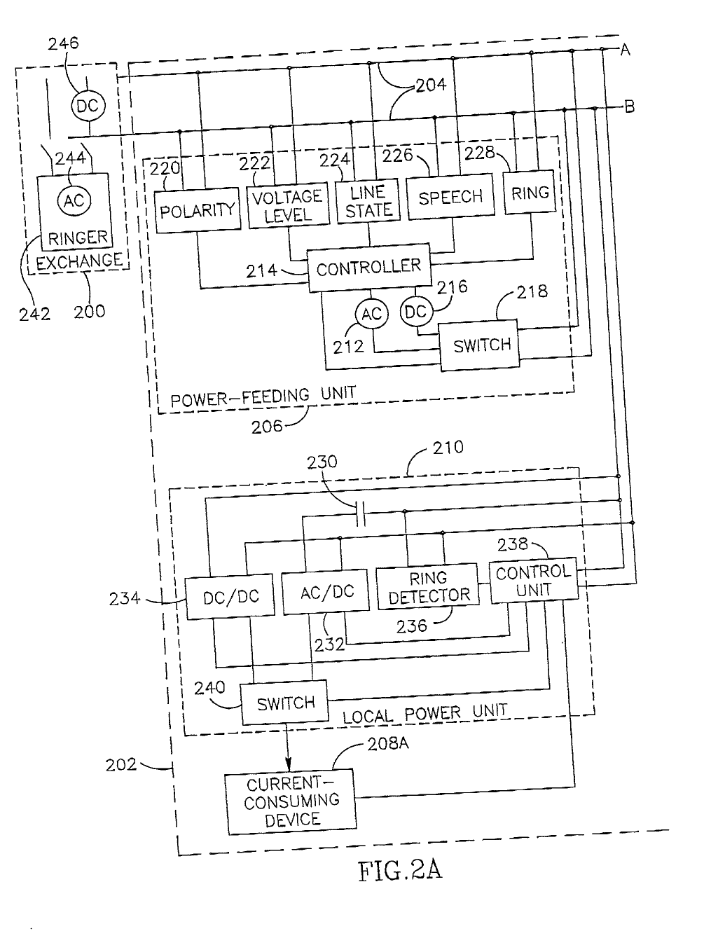

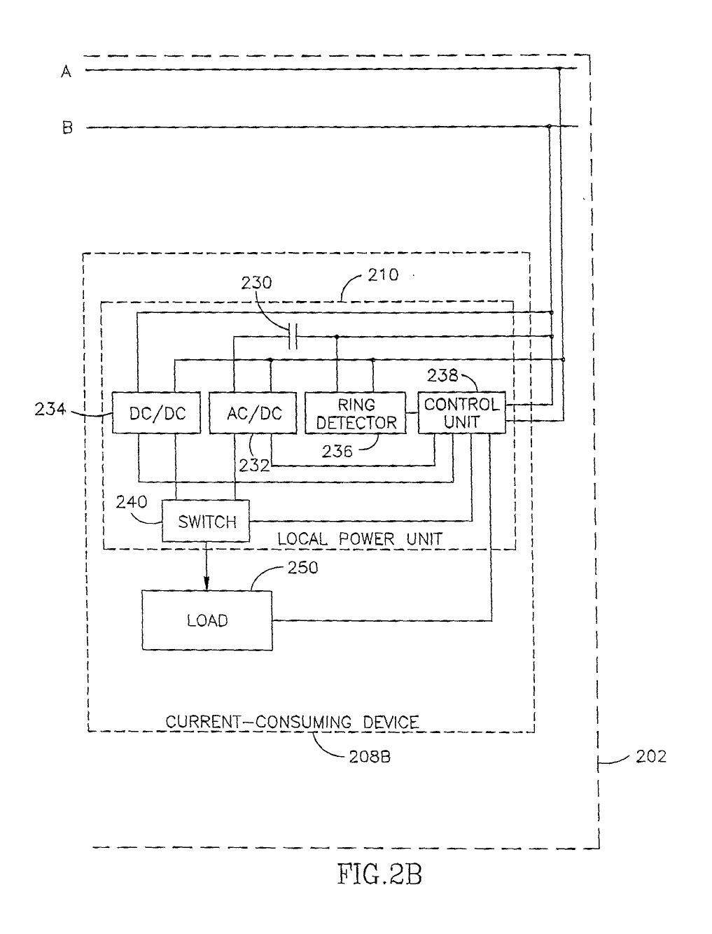

Reference is now made to FIGS. 2A and 2B, which show a block diagram illustration of an exchange 200 and a customer premises 202, according to some embodiments of the present invention. Non-limiting examples of exchange 200 include a private branch exchange (which is located in customer premises 202), a cable exchange and a central office (also known as a public exchange). An electrically conductive line 204 at customer premises 202 may be coupled to exchange 200. Non-limiting examples of line 204 include an internal telephone line and an internal cable.

The following description of certain embodiments of the present invention uses the example of a telephone exchange (private branch exchange or central office) for exchange 200 and an internal telephone line for line 204. However, a person of ordinary skill in the art may modify without undue experimentation the embodiments described hereinbelow to cover other embodiments, for example, including a cable exchange and an internal cable.

Exchange 200 may comprise a DC power supply 246 and a switchably-connectable ringer 242 having an AC power supply 244. Switchably-connectable ringer 242 may be adapted to generate a in signal and AC power supply 244 may be adapted to generate an AC current over line 204 when ringer 242 generates a ring signal.

Customer premises 202 may comprise a power-feeding unit 206 coupled to line 204 and at least one local power unit 210 also coupled to line 204. Customer premises 202 may fisher comprise at least one current-consuming device 208. For example, current-consuming device 208A may be coupled to line 204 via a local power unit 210 that supplies current-consuming device 208A with power. In another example, current-consuming device 208B may be coupled to line 204 and may have local power unit 210 embedded therein.

Power-feeding unit 206 may be adapted to provide power over line 204 to current-consuming devices 208 without disturbing operation of exchange 200 or other devices connected to line 204. In some embodiments of the present invention, power-feeding unit 206 may provide power over line 204 to local power unit 210, which may be coupled to or embedded in current-consuming device 208.

Power-feeding unit 206 may comprise an AC power supply 212, a DC power supply 216 and a controller 214 adapted to control the current, frequency and amplitude of AC power supply 212 and DC power supply 216. Power-feeding unit 206 may also comprise a switching unit 218 adapted to couple one of AC power supply 212 and DC power supply 216 to line 204 according to the state of line 204.

Power-feeding unit 206 may also comprise a polarity detector 220, a voltage level detector 222, a line state detector 224, a speech detector 226 and a ring detector 228, all of which may be coupled to control unit 214 and to line 204. Polarity detector 220 may be adapted to detect the feeding polarity of exchange 200. Voltage level detector 222 may be adapted to detect the voltage of exchange 200, Line state detector 224 may be adapted to detect whether line 204 is in on-hook, off-book or ring state. Speech detector 226 may be adapted to detect when a call is being conducted via line 204 and to alert control unit 214 when the call is being terminated. Ring detector 228 may be adapted to detect ring signals generated by exchange 200.

Control unit 214 may be adapted to receive signals from the detectors and determine the polarity of the voltage coming from exchange 200, the voltage level of exchange 200 and the state of line 204. Control unit 214 may command switching unit 218 to couple one of the AC power supply 212 and DC power supply 216 to line 204 according to the state of line 204.

When the detectors sense an on-hook line state, switching unit 218 may couple AC power supply 212 to line 204. AC power supply 212 may generate an AC current over line 204. Unlike the embodiments of FIG. 1, the frequency of the signals generated by AC power supply 212 may not be restricted and may be below 16 KHz.

When the detectors sense an off-hook line state, switching unit 218 may couple DC power supply 216 to line 204. The DC polarity may be set according to the feeding polarity of exchange 200 as detected by polarity detector 220. DC power supply 216 may generate a DC current over line 204 while maintaining the voltage of line 204 as not to disturb the exchange operation.

When the detectors sense a ring line state, switching unit 218 may be disconnected from DC power supply 216 or both DC power supply 216 and AC power supply 212. In this case, power-feeding it 206 may draw the AC current generated over line 204 by the AC power supply 244 of ringer 242 at exchange 200. When the current flow from ringer 242 may not be sufficient to supply enough voltage to current-consuming device 208, an additional AC current may be generated by AC power supply 212.

Local power unit 210 may comprise a control unit 238 coupled to line 204 and a DC block capacitor 230. Local power unit 210 may further comprise a ring detector 236, an AC/DC converter 232 coupled to line 204 via DC block capacitor 230 and a DC/DC converter 234 coupled to line 204. Local power unit 210 may further comprise a switching unit 240 adapted to couple one of AC/DC converter 232 and DC/DC converter 234 to current-consuming device 208A or to a load 250 of current-consuming device 208B.

Control unit 238 may be adapted to control the operation of local power unit 210 according to the line state. For example, control unit 238 may be adapted to control AC/DC input impedance according to the frequency and amplitude of the power supply. Control unit 238 may also be adapted to control he power state (e.g. maximum consumption, low power, off state and the like) of current-consuming device 208A.

The capacitance of DC block capacitor 230 may be set so that local power unit 210 does not draw current over line 204 from exchange 200. When the line is in an on-hook state, AC power supply 212 may generate an AC current over line 204. Switching unit 240 may couple AC/DC converter 232 to control unit 238 and the AC current may flow through block capacitor 230 to AC/DC converter 232. AC/DC converter 232 may convert the AC line voltage to several DC voltage levels, thus producing power to feed current-consuming device 208A or load 250 in current-consuming device 208B. In the on-hook state, local power unit 210 and power-feeding unit 206 may reflect high DC resistance to maintain the on-hook state of line 204.

When the line is in an off-hook state, DC power supply 216 nay generate a DC current over line 204. Switching unit 240 may couple DC/DC converter 234 to control unit 238 and the DC current may flow DC/DC converter 232. Local power unit 210 may detect the off hook state and may bypass DC block detector 230. DC/DC converter 234 may convert the DC line voltage to several DC voltage levels, thus producing power to feed current-consuming device 208A or load 250 in current-consuming device 208B. In the off-hook state local power unit 210 and power-feeding unit 206 reflect high AC current impedance.

When the line is in a ring state, ring detector 236 may detect the ring signal and control unit 238 may decrease DC block capacitor 230. These conditions reflect high AC impedances in order to minimize the load on ringer 242 of exchange 200.

While certain features of the invention have been illustrated and described herein, many modifications, substitutions, changes, and equivalents will now occur to those of ordinary skill in the art. It is, therefore, to be understood that the appended claw are intended to cover all such modifications and changes as fall within the true spirit of the invention.

What is claimed is:

1. A system in a customer premises comprising:
at least one local power unit coupled to an electrically-conductive line; and
a power-feeding unit coupled to said line, said power-feeding unit adapted to provide power over said line to said at least one local power unit without disturbing operation of an exchange coupled to said line.

2. The system of claim 1, wherein said line is an internal telephone line.

3. The system of claim 1, wherein said line is an internal cable.

4. The system of claim 1, wherein said exchange is a private branch exchange.

5. The system of claim 1, wherein said exchange is a central office.

6. The system of claim 1, wherein said power-feeding unit comprises:
an alternating current power supply; and
a control unit coupled to said alternating current power supply.

7. The system of claim 1, wherein said power-feeding unit comprises:
a line state detector; and
a switch adapted to couple one of an alternating current power supply and a direct current power supply to said line according to a specific line state detected by said line state detector.

8. The system of claim 7, wherein said power-feeding unit further comprises a polarity detector and said direct current power supply is adapted to supply power to said line according to a polarity detected by said polarity detector.

9. The system of claim 7, wherein said power-feeding unit further comprises a voltage detector, a ring detector and a speech detector.

10. The system of claim 1, wherein said at least one local power unit is integrated into a current-consuming device.

11. A power-feeding unit adapted to provide power over an electrically conductive line by feeding alternate current or direct current to said line without disturbing operation of an exchange coupled to said line.

12. The power-feeding unit of claim 11, wherein said line is an internal telephone line.

13. The power-feeding unit of claim 11, wherein said line is an internal cable.

14. A method comprising:
providing power over an internal telephone line without disturbing operation of an exchange coupled to said internal telephone line.

15. The method of claim 14, wherein said providing comprises:
supplying alternating current over said internal telephone line when said internal telephone line is on hook; and
supplying only direct current over said internal telephone line when said internal telephone line is off hook.

16. The method of claim 15 further comprising:
supplying at most an additional alternating current to alternating current arriving from said exchange when said exchange is generating a ring signal on said internal telephone line.

17. A method comprising:
reflecting high DC resistance to an internal telephone line when said internal telephone line is on hook or when an exchange is generating a ring signal on said internal telephone line; and
reflecting high AC impedance to said internal telephone line when said internal telephone line is off hook.

18. A method comprising:
providing power over an electrically conductive line by feeding alternate current or direct current to said line without disturbing operation of an exchange coupled to said line.

19. The method of claim 18, wherein said line is an internal telephone line.

20. The method of claim 18, wherein said line is an internal cable.
